(19) United States
(12) Patent Application Publication
(10) Pub. No.: US 2005/0094562 A1
(43) Pub. Date: May 5, 2005

(54) Methods and devices for reducing total bandwidth when streaming multiple media streams

(76) Inventors: Sumit Roy, Menlo Park, CA (US); Michele Covell, Palo Alto, CA (US); Susie Wee, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/698,606

(22) Filed: Oct. 30, 2003

(51) Int. Cl. G08C 15/00

(52) U.S. Cl. 370/235; 370/395.21

(57) ABSTRACT

Methods and devices for streaming multiple media streams are described. A plurality of media streams is received. A media stream is selected. In one implementation, a service is performed on each of the media streams except for the selected media stream. The service reduces the respective bandwidth of each media stream (except for the selected media stream) so that the total bandwidth of the media streams is reduced. The media streams including the selected media stream are then streamed to their destination. The media streams other than the selected media stream are streamed at less than their initial bandwidth, while the selected media stream is streamed at its initial bandwidth.

### TECHNICAL FIELD

Embodiments of the present invention pertain to streaming media.

### BACKGROUND ART

Television coverage of events, such as news or sporting events, typically uses multiple cameras. The event is captured live, and the audio/video content from each of the cameras is streamed back to a studio, for example. At the studio, the content is edited for broadcast. For example, an editor or producer can elect to broadcast the feed from one camera, then switch to the feed from another camera, and so on. This type of editing is typically performed whether the event is being broadcast live or being recorded for later broadcast.

The content received at the studio is preferably of high broadcast quality as this will provide the best viewing experience. As viewers move to high definition televisions that offer high resolutions and large picture screens, the desire for high broadcast-quality content increases.

The broadcast-quality content from each camera is transmitted via some type of communication network from the event to the studio. Typically, the content is transmitted via a wireless network such as a satellite network. Alternatively, the Internet can be used.

However, and especially when multiple cameras are being used, a substantial amount of network bandwidth is needed to transmit the content to the studio. If the available bandwidth is insufficient, then there can be delays in receiving the content, an unsatisfactory situation particularly for events being broadcast live.

Some conventional solutions address this problem by attempting to reserve a large amount of network bandwidth. However, reserving network bandwidth, especially in the amount needed, is expensive. Also, it may not be possible to reserve the bandwidth needed. For example, for breaking news events, it is not always possible to know in advance when and for long a large amount of bandwidth will be needed.

Other conventional solutions attempt to sidestep the network bandwidth issue by capturing the content on storage devices such as video tapes or hard disks, and shipping the storage devices to the studio. While these solutions may be satisfactory in some instances, they are not satisfactory for live events or for those events in which there is interest in getting footage on the air as quickly as possible.

Yet other conventional solutions attempt to address these problems by sending low bandwidth (e.g., low resolution) content over the communication network. However, this does not satisfy the preference for high resolution content at the broadcast source, as mentioned above.

Thus, a method and/or system that can deliver broadcast quality content for an event covered by multiple cameras would be of value.

### DISCLOSURE OF THE INVENTION

Embodiments of the present invention pertain to methods and devices for streaming multiple media streams.

In one embodiment, a plurality of media streams is received. A media stream is selected. A service is performed on each of the media streams except for the selected media stream. The service reduces the respective bandwidth of each media stream (except for the selected media stream) so that the total bandwidth of the media streams is reduced. The media streams including the selected media stream are then streamed to their destination. The media streams other than the selected media stream are streamed at less than their initial bandwidth, while the selected media stream is streamed at its initial bandwidth.

In another embodiment, a plurality of media streams is received as described above. A service is performed on each of the media streams, the service reducing a respective initial bandwidth of each media stream. All of the media streams are streamed to their destination at less than their respective initial bandwidths. At least one media stream is then selected from the plurality of media streams. The selected media stream is streamed at its initial bandwidth.

### BRIEF DESCRIPTION OF THE DRAWINGS

The accompanying drawings, which are incorporated in and form a part of this specification, illustrate embodiments of the invention and, together with the description, serve to explain the principles of the invention:

FIGS. 1A and 1B illustrate data flow in a data streaming system according to one embodiment of the present invention.

FIGS. 2A and 2B illustrate data flow in a data streaming system according to another embodiment of the present invention.

FIG. 3 illustrates data flow in a data streaming system according to a third embodiment of the present invention.

FIG. 4 illustrates data flow in a data streaming system according to a fourth embodiment of the present invention.

FIG. 5 is a flowchart of one embodiment of a method of streaming data according to the present invention.

FIG. 6 is a flowchart of another embodiment of a method of streaming data according to the present invention.

The drawings referred to in this description should not be understood as being drawn to scale except if specifically noted.

### BEST MODE FOR CARRYING OUT THE INVENTION

Reference will now be made in detail to various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following description of the present invention, numerous specific details are set forth in order to provide a thorough understanding of the present invention. In other instances, well-known methods, procedures, components, and circuits have not been described in detail as not to unnecessarily obscure aspects of the present invention.

Aspects of the present invention may be practiced on an intelligent device such as a computer system that includes, in general, a processor for processing information and instructions, random access (volatile) memory (RAM) for storing information and instructions, read-only (non-volatile) memory (ROM) for storing static information and instructions, a data storage device such as a magnetic or optical disk and disk drive for storing information and instructions, an optional user output device such as a display device (e.g., a monitor) for displaying information to the computer user, an optional user input device including alphanumeric and function keys (e.g., a keyboard) for communicating information and command selections to the processor, and an optional user input device such as a cursor control device (e.g., a mouse) for communicating user input information and command selections to the processor.

For purposes of clarity and brevity, the following discussion and examples deal with video data and audio data; however, the present invention is not so limited. In general, the present invention is well suited to use with image-based data and audio-based data and the like, referred to generally herein as media data.

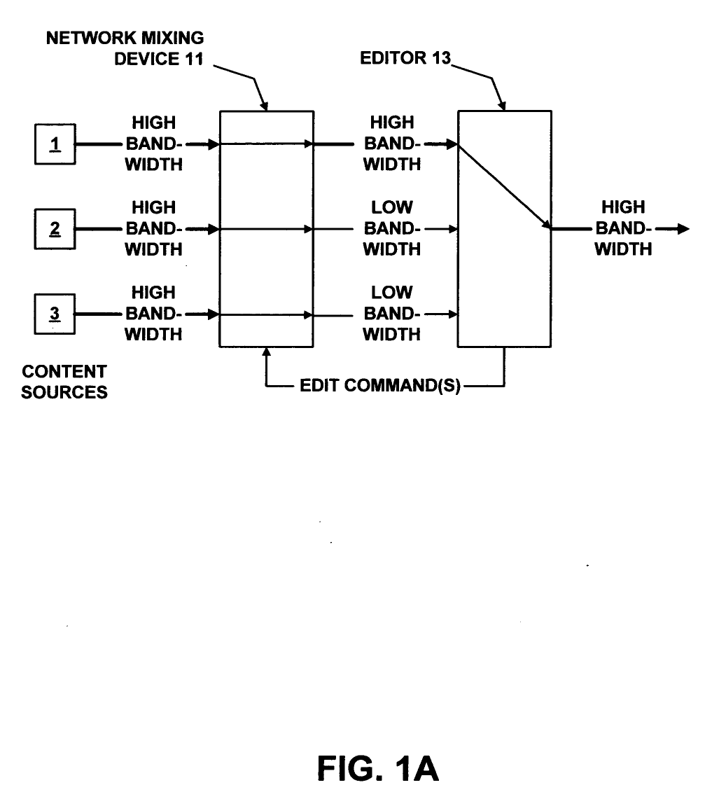

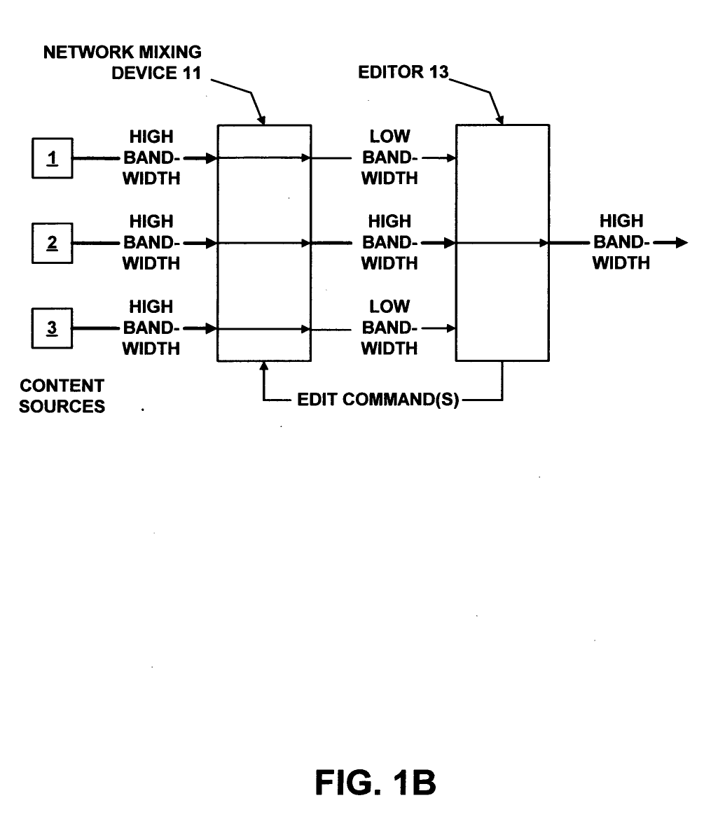

FIGS. 1A and 1B illustrate data flow in a data streaming system according to one embodiment of the present invention. In the present embodiment, content sources 1, 2 and 3 are communicatively coupled to network mixing device 11, which in turn is communicatively coupled to editor device 13. The content sources 1, 2 and 3, the network mixing device 11, and the editor device 13 communicate with each other over a communication network. The communication network may be a satellite network, an Internet Protocol network, or the like. The content sources 1, 2 and 3, the network mixing device 11, and the editor device 13 can therefore be in completely separate and perhaps distant locations.

As will be seen, network mixing device 11 functions to reduce the total bandwidth associated with delivering content in real time from content sources 1, 2 and 3 to the editor device 13. Accordingly, editor device 13 can be a great distance from the content sources 1, 2 and 3 without placing great demands on the communication network. The closer that network mixing device 11 is located to the content sources 1, 2 and 3, the lower the demands on the communication network.

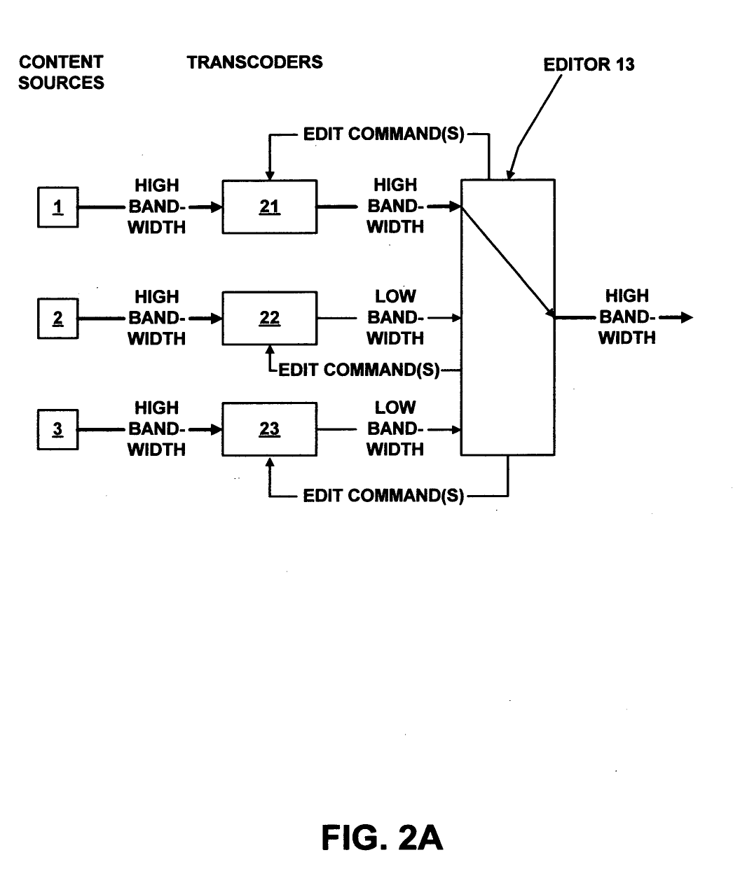

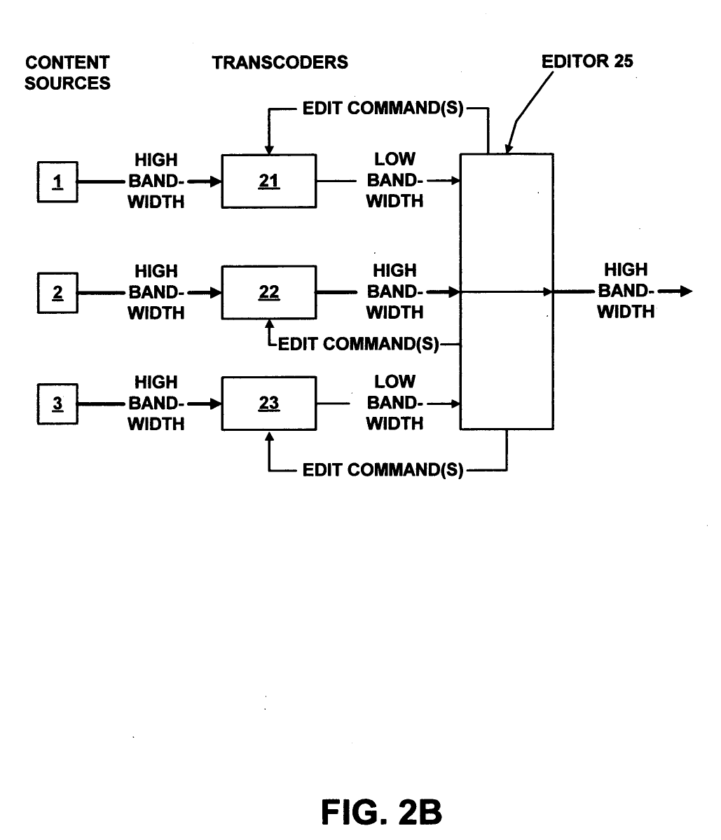

In the examples of FIGS. 1A and 1B, as well as in the other examples described below in conjunction with FIGS. 2A, 2B, 3 and 4, it is understood that there may be one or more other nodes situated between the content sources and the network mixing device, and/or between the network mixing device and the editor device, as part of the communication network. Also, although three content sources are described, the present invention is not so limited. Furthermore, an editor device may be in communication with more than one network mixing device. Moreover, there may be more than one editor device, perhaps centrally controlled by another device.

Referring to FIGS. 1A and 1B, the content sources 1, 2 and 3 communicate to the network mixing device 11, and the network mixing device 11 communicates to the editor device 13, and vice versa, via wired or wireless communication or some combination thereof. Communications from the content sources 1, 2 and 3 to the network mixing device 11 are via one or more high bandwidth connections. Communications from the network mixing device 11 to the editor device 13 can occur over connections that have high bandwidth capacity; however, as will be seen, the total bandwidth consumed by communications from the network mixing device 11 to the editor device 13 are reduced relative to conventional approaches. Communications from the editor device 13 to the network mixing device 11 consist primarily of editing commands sent from the editor device 13 to the network mixing device 11; those communications can occur through a low bandwidth connection.

In general, content sources 1, 2 and 3 are high bitrate (high resolution) streaming media sources. In one embodiment, content sources 1, 2 and 3 are cameras, specifically moving picture (e.g., video) cameras that can also record audio input. As cameras, the content sources 1, 2 and 3 can be used during coverage of a live event (e.g., a news event or sporting event). The cameras may provide simultaneous but different views of a single physical area (e.g., a football field) or simultaneous recordings of physically separate areas (e.g., opposing campaign centers during an election). Images and sounds of the event can be captured in digital form, or in another form that is converted to digital form by either the content sources 1, 2 and 3 or by a downstream device (e.g., by network mixing device 11). Content can be sent (e.g., streamed) from the content sources 1, 2 and 3 as the content is captured (e.g., in real time), or the content can be recorded, in whole or in part, and then sent. Significantly, the content sent from the content sources 1, 2 and 3 to the network mixing device 11 is high bandwidth (e.g., high resolution, broadcast quality) content. Although the content from the content sources 1, 2 and 3 can include both video and audio content, the present invention is not so limited.

Thus, network mixing device 11 receives high bandwidth feeds (e.g., media streams) from each of the content sources 1, 2 and 3. Network mixing device 11 performs processing of the audio and video content in selected media streams to reduce the bandwidth associated with the media streams selected. Based on information received from the editor device 13, network mixing device 11 can identify which media streams are to be processed to reduce bandwidth, and which media stream or streams are not to be processed to reduce bandwidth. It is appreciated that processing—other than processing to reduce bandwidth—might be performed by network mixing device 11 on all of the media streams.

Processing operations that reduce the bandwidth of a media stream are referred to herein as transcoding operations. Transcoding operations include, but are not limited to, bitrate reduction, rate shaping, spatial downsampling (spatial resolution reduction), frame rate reduction, key frame selection, changing compression formats, data packet truncation, and data packet elimination. These transcoding operations, as well as various other transcoding operations not mentioned, are known in the art.

Editor device 13 in essence provides remote control of the network mixing device 11. Varying degrees of control can be exerted over network mixing device 11 by editor device 13. In general, commands generated by a human editor are sent from the editor device 13 to the network mixing device 11. The commands are used to identify which of the media streams received by network mixing device 11 are to be processed to reduce bandwidth. The commands may be compiled into a list (an edit list) which is sent to network mixing device 11, which then executes the commands in order according to the list. In one embodiment, commands are sent to the network mixing device 11 using Synchronized Multimedia Integration Language (SMIL) files.

The examples of FIGS. 1A and 1B are now described in operation. In FIG. 1A, a live event is captured, in picture and/or sound, by content sources 1, 2 and 3. High bandwidth (e.g., high definition, high bitrate, etc.) content from content sources 1, 2 and 3 is sent (e.g., streamed) to network mixing device 11. In response to a command from editor device 13, the content from content source 1 is selected as the feed (e.g., clip) to be broadcast (e.g., televised). Accordingly, the content from content source 1 is not processed to reduce its associated bandwidth, and the content from content sources 2 and 3 is processed (e.g., transcoded) to reduce their respective bandwidths.

Note that, before processing to reduce bandwidth, all or some portion of the high bandwidth media streams from the content sources 1, 2 and 3 can be recorded on some type of storage device (e.g., on video tape or on a hard disk). In this manner, the high bandwidth content from all of the content sources can be retained and subsequently processed and edited, if so desired.

In one embodiment, the same transcoding operation is applied to content sources 2 and 3. In another embodiment, different types of transcoding operations are applied on a stream-by-stream basis. In one embodiment, the commands sent from editor device 13 control the type of transcoding performed by network mixing device 11, collectively or on a stream-by-stream basis. In other words, all media streams may be subject to the same transcoding operation, or each stream may be subject to different transcoding operations. Also, for any given stream, one type of transcoding operation may be applied, and then a change to a different type of transcoding operation may be made.

In the present embodiment, all of the media streams are sent (e.g., streamed) over a communication network to the editor device 13. The high bandwidth version of the media stream from content source 1, and the low bandwidth versions of the media streams from content sources 2 and 3, are sent to editor device 13. All of the media streams are sent to editor device 13 so that a human editor or producer can make subsequent decisions about which of the feeds are to be broadcast.

According to the present embodiment of the present invention, although all of the media streams are sent to the editor device 13, the total bandwidth consumed by the streams is reduced relative to the conventional art because some of the streams are transcoded. In the example of FIGS. 1A and 1B, only a single high bandwidth media stream is sent over the communication network; however, the present invention is not so limited. Even if more than one high bandwidth stream is sent to the editor device 13, a reduction in total bandwidth consumed is still realized as long as at least one of the content streams from the content sources 1, 2 and 3 is reduced in bandwidth.

Note that the transcoding operation is generally intended to reduce bandwidth, but the type of transcoding can be selected so that characteristics of the content that might be of particular interest can be retained even at reduced bandwidth. For example, a reduction in spatial resolution might make it difficult for a remote editor to discern whether or not a video camera has proper focus. Therefore, instead of transcoding by reducing spatial resolution, transcoding by key frame selection may be selected. The key frames are at high resolution but the bandwidth needed to send them to the editor device 13 is reduced by virtue of a reduced frame count. As noted above, the type of transcoding can be controlled on a stream-by-stream basis, and a change can be made from one type of transcoding operation to another.

Referring now to FIG. 1B, a decision is made to broadcast (e.g., televise) the feed from content source 2. In the present embodiment, to implement this decision, a command is sent from editor device 13 to network mixing device 11. In response to the command, network mixing device 11 starts transcoding of the media stream from content source 1 and continues transcoding of the media stream from content source 3, in order to reduce the bandwidth associated with those media streams. Also, network mixing device 11 stops transcoding of the media stream from content source 2. The high bandwidth version of the media stream from content source 2, and the low bandwidth versions of the media streams from content sources 1 and 3, are sent to editor device 13. This process can be repeated as many times as needed or desired.

FIGS. 2A and 2B illustrate data flow in a data streaming system according to another embodiment of the present invention. In general, the examples of FIGS. 2A and 2B share the features described above in conjunction with the examples of FIGS. 1A and 1B. A difference between the examples of FIGS. 1A and 1B and the examples of FIGS. 2A and 2B is that, in the latter examples, a separate transcoder device is associated with each content source (e.g., transcoders 21, 22 and 23 are separately associated with content sources 1, 2 and 3, respectively). It is understood that a system combining the examples of FIGS. 1A, 1B, 2A and 2B is possible. In such a system, some content sources may share a transcoder device (e.g., a network mixing device), while other content sources may be associated with a dedicated transcoder.

With reference to FIGS. 2A and 2B, the transcoders 21, 22 and 23 can each receive commands from the editor device 25. Thus, although the transcoders 21-23 are to a degree independent of each other, they operate under control of the editor device 25 and, in community, are similar in function to the network mixing device 11 of FIGS. 1A and 1B.

The examples of FIGS. 2A and 2B are now described in operation. In FIG. 2A, a live event is captured, in picture and/or sound, by content sources 1, 2 and 3. High bandwidth (e.g., high definition, high bitrate, etc.) content from content sources 1, 2 and 3 is sent (e.g., streamed) to transcoders 21, 22 and 23, respectively. The content from content source 1 is selected as the feed (e.g., clip) to be broadcast (e.g., televised). Accordingly, in response to a command from editor device 25, the content from content source 1 is not processed by transcoder 21 to reduce bandwidth. Also in response to commands from editor device 25, the content from content sources 2 and 3 is processed (e.g., transcoded) by transcoders 22 and 23, respectively, to reduce bandwidths. The type of transcoding performed at each transcoder can be the same or different.

In the present embodiment, all of the media streams are sent (e.g., streamed) over a communication network to the editor device 25. The high bandwidth version of the media stream from content source 1, and the low bandwidth versions of the media streams from content sources 2 and 3, are sent to editor device 25. As previously discussed herein, although all of the media streams are sent to the editor device 25, the total bandwidth consumed by the streams is reduced relative to the conventional art because some of the streams are transcoded. In the example of FIGS. 2A and 2B, only a single high bandwidth media stream is sent over the communication network; however, the present invention is not so limited.

Referring now to FIG. 2B, a decision is made to broadcast (e.g., televise) the feed from content source 2. In the present embodiment, to implement this decision, a command is sent from editor device 25 to transcoders 21 and 22. In response to the commands, transcoder 21 starts transcoding of the media stream from content source 1 in order to reduce bandwidth, and transcoder 22 stops transcoding of the media stream from content source 2. A command from editor 25 can also be sent to transcoder 23 to continue transcoding; however, the absence of such a command will also suffice. The high bandwidth version of the media stream from content source 2, and the low bandwidth versions of the media streams from content sources 1 and 3, are sent to editor device 25. This process can be repeated as many times as needed or desired.

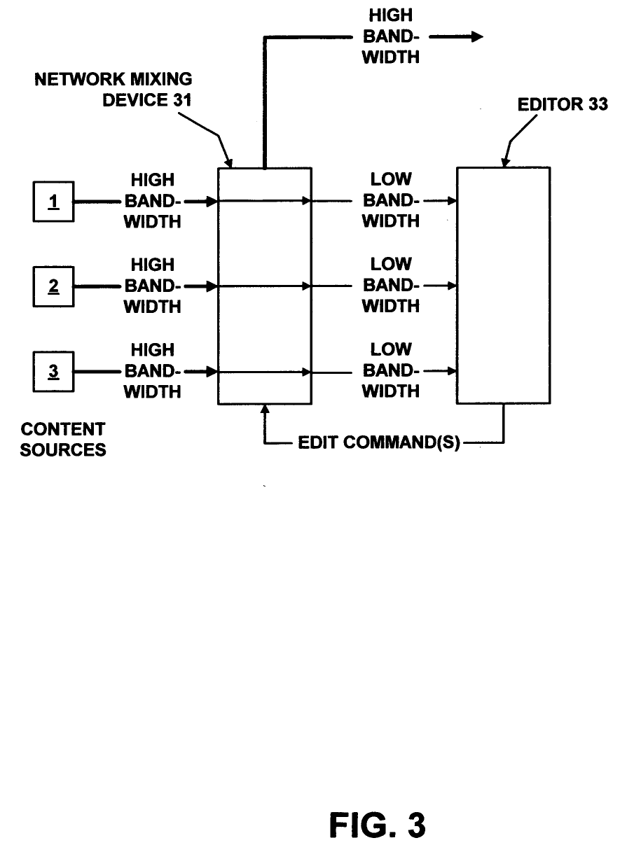

FIG. 3 illustrates data flow in a data streaming system according to a third embodiment of the present invention. In general, the example of FIG. 3 shares the features described above in conjunction with the examples of FIGS. 1A and 1B. A difference between the examples of FIGS. 1A and 1B and the example of FIG. 3 is that, in the latter example, all of the media streams are reduced in bandwidth before they are sent to editor device 33. Accordingly, editor device 33 receives only the low bandwidth versions of the media streams. Based on the low bandwidth versions, a decision can be made to select for broadcast one of the high bandwidth feeds from the content sources 1, 2 and 3. A command from editor device 33 identifies the content source selected for broadcast. Network mixing device 31 can then either broadcast the selected high bandwidth feed, or network mixing device 31 can forward the selected high bandwidth feed to a downstream node other than the editor device 33. The other downstream node might be a broadcaster closer to the network mixing device 31 than the editor device 33, so the demand placed on the communication network is reduced.

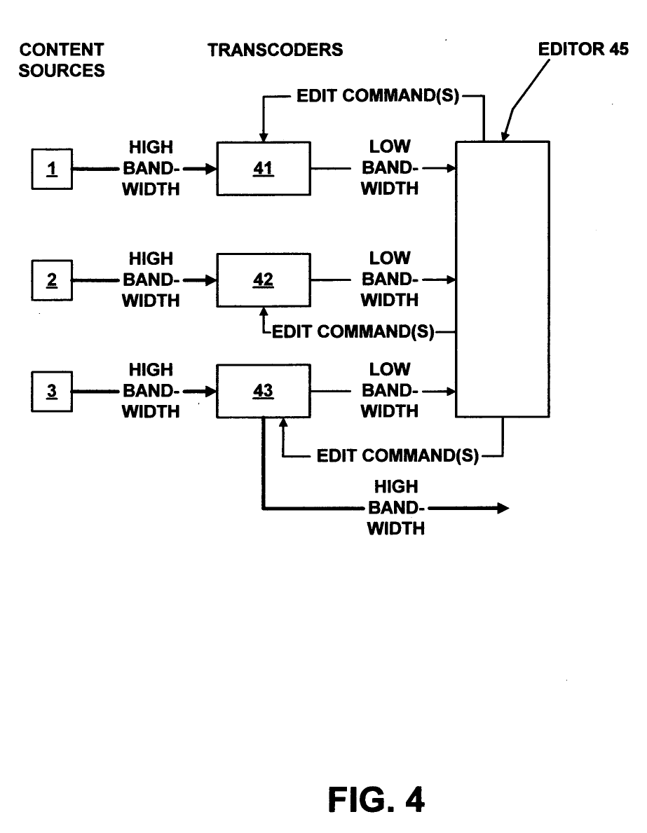

FIG. 4 illustrates data flow in a data streaming system according to a fourth embodiment of the present invention. In general, the example of FIG. 4 shares the features described above in conjunction with the examples of FIGS. 2A and 2B. A difference between the examples of FIGS. 2A and 2B and the example of FIG. 4 is that, in the latter example, all of the media streams are reduced in bandwidth before they are sent to editor device 45. Accordingly, editor device 45 receives only the low bandwidth versions of the media streams. Based on the low bandwidth versions, a decision can be made to select for broadcast one of the high bandwidth feeds from the content sources 1, 2 and 3. Commands from editor device 45 identify the content source selected for broadcast. In the example of FIG. 4, the content from content source 3 is selected for broadcast. Transcoder 43 can then either broadcast the selected high bandwidth feed, or transcoder 43 can forward the selected high bandwidth feed to a downstream node other than the editor device 45.

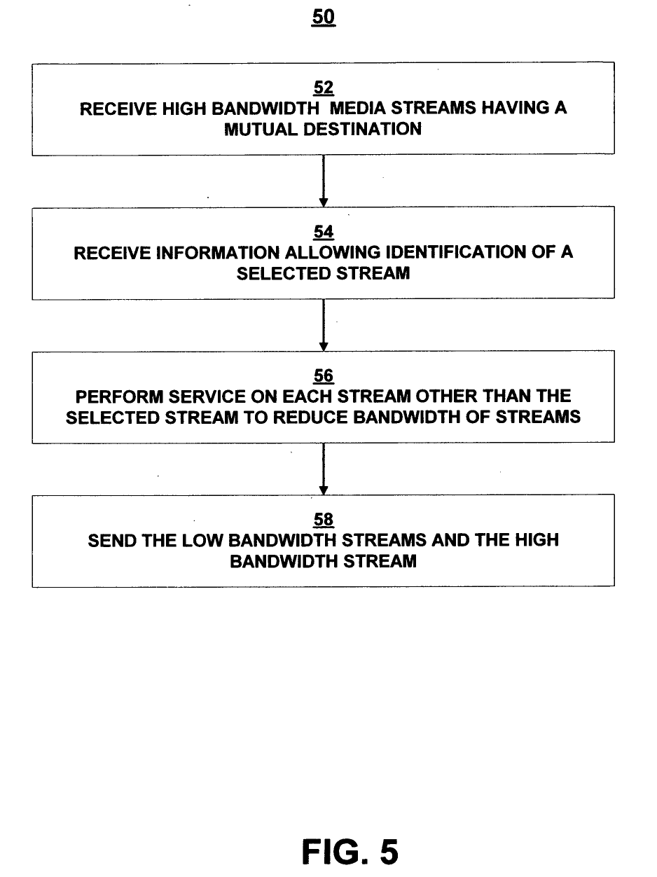

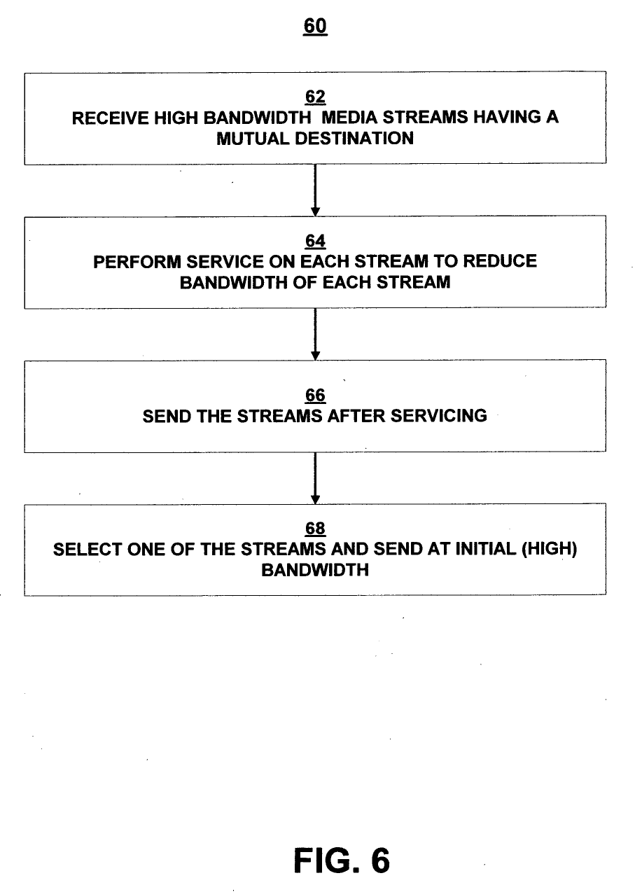

FIG. 5 is a flowchart 50 of one embodiment of a method of streaming data according to the present invention. FIG. 6 is a flowchart 60 of another embodiment of a method of streaming data according to the present invention. Although specific steps are disclosed in flowcharts 50 and 60, such steps are exemplary. That is, embodiments of the present invention are well suited to performing various other steps or variations of the steps recited in flowcharts 50 and 60. It is appreciated that the steps in flowcharts 50 and 60 may be performed in an order different than presented, and that not all of the steps in flowcharts 50 and 60 may be performed. All of, or a portion of, the methods described by flowcharts 50 and 60 can be implemented using computer-readable and computer-executable instructions which reside, for example, in computer-usable media of a computer system or like device.

In one embodiment, flowchart 50 pertains to the examples of FIGS. 1A, 1B and 3. In such an embodiment, flowchart 50 is implemented using network mixing devices 11 and 31 of those figures. In one embodiment, flowchart 60 pertains to the examples of FIGS. 2A, 2B and 4. In such an embodiment, flowchart 60 is implemented by transcoders 21-23 and 41-43 of those figures.

Referring first to step 52 of FIG. 5, in the present embodiment, a plurality of media streams is received. In step 54, a media stream is selected. In one embodiment, information is received identifying which media stream is to be selected.

In step 56, a service is performed on each of the media streams except for the selected media stream. The service reduces the respective bandwidth of each media stream (except for the selected media stream) so that the total bandwidth of the media streams is reduced. In one embodiment, a different type of service can be performed on each of the media streams. In another embodiment, the same service is performed on all media streams. In those embodiments, information is received identifying the type of service(s) to be performed. Also, in one embodiment, the information in the media streams is recorded before the service is performed.

In step 58, the media streams including the selected media stream are then streamed to their destination. The media streams other than the selected media stream are streamed at less than their initial bandwidth, while the selected media stream is streamed at its initial bandwidth.

Referring now to step 62 of FIG. 6, in the present embodiment, a plurality of media streams is received.

In step 64, a service is performed on each of the media streams. The service reduces a respective initial bandwidth of each media stream. In one embodiment, a different type of service can be performed on each of the media streams. In another embodiment, the same service is performed on all media streams. In those embodiments, information is received identifying the type of service(s) to be performed. Also, in one embodiment, the information in the media streams is recorded before the service is performed.

In step 66, all of the media streams are streamed to their destination at less than their respective initial bandwidths.

In step 68, at least one media stream is then selected from the plurality of media streams. In one embodiment, information is received identifying which media stream is to be selected. The selected media stream is streamed at its initial bandwidth.

In summary, embodiments of the present invention provide methods and systems that can deliver broadcast quality content in real time for a live event covered by multiple cameras. The invention utilizes a network mixing device that is relatively close to the content sources and that produces low bandwidth versions of media streams but still provides a high bandwidth, broadcast quality stream. In effect, embodiments of the invention allow for pre-selection of content far from the event site, based on lower bandwidth representations, with only the selected content then fed at broadcast quality. This considerably reduces the total bandwidth needed to transmit broadcast quality content from multiple content sources over large distances without introducing large delays from the time that the content is captured until the time the content is disseminated (e.g., televised).

Reducing the bandwidth needed for live event coverage avoids the need to set aside large amounts of bandwidth, reducing costs. Also, more efficient use of communication network resources is realized, considering that the product that is broadcast can only utilize one high quality feed at a time. In other words, network resources are not consumed by sending many high quality streams when only one of the streams is needed at a time. Because the other content feeds are also transmitted, although at lower bandwidth, a human editor still has fine grain control over how to composite the product that is broadcast.

The foregoing descriptions of specific embodiments of the present invention have been presented for purposes of illustration and description. They are not intended to be exhaustive or to limit the invention to the precise forms disclosed, and it is evident many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

1. A method of streaming media, said method comprising:
receiving a plurality of media streams, said plurality of media streams having a mutual downstream destination and a total bandwidth associated therewith;
receiving information allowing identification of a selected media stream;
performing a service on each of said media streams except for said selected media stream, said service reducing a respective initial bandwidth of each media stream other than said selected media stream so that said total bandwidth is reduced; and
streaming said plurality of media streams, wherein said media streams other than said selected media stream are streamed at less than their respective initial bandwidths.

2. The method of claim 1 wherein said service comprises a transcoding operation.

3. The method of claim 2 wherein said transcoding operation is selected from the group consisting of bitrate reduction, rate shaping, spatial downsampling, spatial resolution reduction, frame rate reduction, key frame selection, a change in compression format, data packet elimination, and data packet truncation.

4. The method of claim 1 further comprising:
receiving information identifying a type of service to be performed.

5. The method of claim 1 wherein a single device receives said media streams and performs said service.

6. The method of claim 1 wherein said media streams are received at respective devices, each device servicing a respective media stream.

7. The method of claim 1 wherein said information is generated according to an edit list comprising instructions for editing said media streams.

8. The method of claim 1 further comprising:
recording said media streams prior to said performing of said service.

9. A method of streaming media, said method comprising:
receiving a plurality of media streams, said plurality of media streams having a mutual downstream destination and respective initial bandwidths associated therewith;
performing a service on each of said media streams, said service reducing a respective initial bandwidth of each media stream;
streaming said plurality of media streams at less than their respective initial bandwidths;
selecting at least one media stream from said plurality of media streams; and
streaming said at least one media stream at its initial bandwidth.

10. The method of claim 9 wherein said service comprises a transcoding operation.

11. The method of claim 10 wherein said transcoding operation is selected from the group consisting of bitrate reduction, rate shaping, spatial downsampling, spatial resolution reduction, frame rate reduction, key frame selection, a change in compression format, data packet elimination, and data packet truncation.

12. The method of claim 9 further comprising:
receiving information identifying a type of service to be performed.

13. The method of claim 9 wherein a single device receives said media streams and performs said service.

14. The method of claim 9 wherein said media streams are received at respective devices, each device servicing a respective media stream.

15. The method of claim 9 wherein said selecting is made according to an edit list comprising instructions for editing said media streams.

16. The method of claim 9 further comprising:
recording said media streams prior to said performing of said service.

17. A computer-usable medium having computer-readable program code embodied therein for causing a network mixing device to perform a method of streaming media, said method comprising:
receiving a plurality of media streams, said plurality of media streams having a mutual downstream destination and a total bandwidth associated therewith;
executing an operation on each of said media streams except for at least one media stream, said operation reducing a respective initial bandwidth of each media stream other than said at least one media stream so that said total bandwidth is reduced; and
streaming said plurality of media streams, wherein said media streams other than said at least one media stream are streamed at less than their respective initial bandwidths.

18. The computer-usable medium of claim 17 wherein said operation comprises transcoding.

19. The computer-usable medium of claim 17 wherein said operation is selected from the group consisting of bitrate reduction, rate shaping, spatial downsampling, spatial resolution reduction, frame rate reduction, key frame selection, a change in compression format, data packet elimination, and data packet truncation.

20. The computer-usable medium of claim 17 wherein said at least one media stream is selected in response to an edit list comprising instructions for editing said media streams.

21. The computer-usable medium of claim 17 wherein said computer-readable program code embodied therein causes said network mixing device to perform said method further comprising:
recording said media streams prior to said executing of said operation.

22. A computer-usable medium having computer-readable program code embodied therein for causing a network mixing device to perform a method of streaming media, said method comprising:
receiving a plurality of media streams, said plurality of media streams having a mutual downstream destination and respective initial bandwidths associated therewith;
executing an operation on each of said media streams, said operation reducing a respective initial bandwidth of each media stream;
streaming said plurality of media streams at less than their respective initial bandwidths;
receiving information selecting at least one media stream from said plurality of media streams; and
streaming said at least one media stream at its initial bandwidth.

23. The computer-usable medium of claim 22 wherein said operation comprises transcoding.

24. The computer-usable medium of claim 22 wherein said operation is selected from the group consisting of bitrate reduction, rate shaping, spatial downsampling, spatial resolution reduction, frame rate reduction, key frame selection, a change in compression format, data packet elimination, and data packet truncation.

25. The computer-usable medium of claim 22 wherein said information for selecting comprises instructions for editing said media streams.

26. The computer-usable medium of claim 22 wherein said computer-readable program code embodied therein causes said network mixing device to perform said method further comprising:
recording said media streams prior to said executing of said operation.
